(19) United States
(12) Patent Application Publication
(10) Pub. No.: US 2020/0192668 A1
(43) Pub. Date: Jun. 18, 2020

(54) SYSTEMS AND METHODS OF PERFORMING PROBE INJECTION USING INSTRUCTION PUNNING

(71) Applicant: Indiana University Research and Technology Corporation, Indianapolis, IN (US)

(72) Inventors: Ryan R. Newton, Bloomington, IN (US); Buddhika Chamith De Alwis Kahawitage Don, Bloomington, IN (US)

(73) Assignee: Indiana University Research and Technology Corporation, Indianapolis, IN (US)

(21) Appl. No.: 16/623,635

(22) PCT Filed: Jun. 18, 2018
(86) PCT No.: PCT/US2018/038039

§ 371 Date: Dec. 17, 2019

Related U.S. Application Data
(60) Provisional application No. 62/521,510, filed on Jun. 18, 2017.

(51) Int. Cl. G06F 9/30; G06F 9/35; G06F 11/36

(52) U.S. Cl. CPC G06F 9/30181; G06F 11/3644; G06F 9/35

(57) ABSTRACT

A method provides for injecting a probe (302) into a computer-readable computer program having a plurality of computer-executable instructions (134). In one example, the method includes receiving the plurality of computer-executable instructions (134) from memory (130); identifying at least one original instruction (308) from the received plurality of computer-executable instructions (134) for facilitating insertion of the probe (302); creating a temporary copy of the at least one original instruction (308); and allocating a jump target of the probe (302) to a memory address in the memory (130) by assigning a predetermined value to tail bytes (312) of the probe (302).

### RELATED APPLICATIONS

The present disclosure is related to and claims priority to U.S. Provisional Application No. 62/521,510, entitled “SYSTEMS AND METHODS OF PERFORMING PROBE INJECTION USING INSTRUCTION PUNNING,” filed on Jun. 18, 2017, the entire disclosure of which is hereby expressly incorporated herein by reference.

This invention was made with government support under 1337242 awarded by National Science Foundation. The government has certain rights in the invention.

### FIELD OF THE DISCLOSURE

The present disclosure generally relates to probe injection systems and methods. More particularly, the present disclosure relates to systems and methods for dynamically injecting probes into running software.

### BACKGROUND OF THE DISCLOSURE

Dynamic probe injection is a method of modifying the behavior of software being executed in production, often for debugging performance. Probes are additional procedure calls generated and attached to code at runtime. Conventional techniques rely on certain approaches, all of which have performance problems or limited functionality. The first approach enables dynamic probing of native binary code by relying on an expensive pausing approach where binary code changes are made within a safe state of the running software. Typically, all program threads are halted to ensure that another thread executing a modified code region of the software does not encounter a partially-modified code. The pausing approach is not scalable and causes a significant overhead that decelerates the performance of software. Second, several approaches use operating system support for “trap” instructions, which can be injected without stopping the application, but are slow to invoke. Third, some techniques pre-arrange for probes at certain code locations, but are limited by not being able to probe at any instruction. Thus, conventional techniques for injecting the probes into running code are limited because they fail to support probing arbitrary locations or fail to support high performance injection, activation/deactivation, and execution of probes. As such, there are opportunities to develop an improved probe injection system and method that can enhance the performance of dynamic probing.

### SUMMARY

In one embodiment of the present disclosure, a method is provided of injecting a probe into a computer-readable computer program having a plurality of computer-executable instructions using a computing device. Included in the method are receiving, using the computing device, the plurality of computer-executable instructions from memory; identifying, using the computing device, at least one original instruction from the received plurality of computer-executable instructions for facilitating insertion of the probe (or the probe site); creating, using the computing device, a temporary copy of the at least one original instruction; and allocating, using the computing device, a jump target of the probe to a memory address in the memory by assigning a predetermined value to tail bytes of the probe. The probe site consists of multiple bytes, only some of which need to change to transform the probe site into a jump. In one example, head byte(s) of the probe site are defined as an opcode indicating a jump instruction, and tail byte(s) as the target address for the jump.

In one aspect of the embodiment, the method includes determining, using the computing device, whether the allocation of the jump target of the probe is successful based on availability of the memory address indicated by the tail byte(s). Further, the method includes generating, using the computing device, an injected instruction embedded with the probe based on the allocated jump target of the probe; and initializing, using the computing device, the injected instruction with the probe having an opcode and a “pun” based on the allocated jump target. The pun serves as both the target address of the jump and as executable instructions if and only if the probe site previously contained executable instructions at those locations.

In another aspect of the embodiment, the method includes responding to the injected instruction being split across memory boundaries (such as cache lines) at a probe site by patching, using the computing device, the injected instruction based on the opcode and the pun; and activating, using the computing device, the probe in the injected instruction based on a validity of the pun. In one example, the method includes searching, using the computing device, for a memory space for the pun by replacing zero or more of the tail bytes such that the jump target is mappable in the memory.

In yet another aspect of the embodiment, the method includes deactivating, using the computing device, one or more operations in the tail bytes of the probe site with an illegal or trap instruction. For example, deactivation of the one or more operations is performed when the memory address is unavailable. In one example, the method includes replacing, using the computing device, a head byte of the original instruction with a jump instruction opcode. In another example, the method includes searching, using the computing device, for a cached version of the injected instruction embedded with the probe.

In another embodiment of the present disclosure, a computing device has a processor operative to inject a probe into a computer-readable computer program having a plurality of computer-executable instructions. The processor is configured to: receive the plurality of computer-executable instructions from memory; identify at least one original instruction from the received plurality of computer-executable instructions for facilitating insertion of the probe; create a temporary copy of the at least one original instruction; and allocate a jump target of the probe to a memory address in the memory by assigning a predetermined value to tail bytes of the probe.

In one aspect of the embodiment, wherein the processor is further configured to determine whether the allocation of the jump target of the probe is successful based on an availability of the memory address, and wherein the processor is further configured to generate an injected instruction embedded with the probe based on the allocated jump target of the probe. In another aspect of the embodiment, wherein the processor is further configured to initialize the injected instruction with the probe having an opcode and a pun based on the allocated jump target. In yet another aspect of the embodiment, wherein the processor is further configured to: respond to the injected instruction being divided at a probe site by patching the injected instruction based on the opcode and the pun; and activate the probe in the injected instruction based on a validity of the pun.

In one example, the processor is further configured to: search for a memory space for the pun by replacing zero or more of the tail bytes such that the jump target is mappable in the memory; and deactivate one or more operations in the tail bytes with an illegal or trap instruction when the memory address is unavailable. In another example, the processor is further configured to: replace a head byte of the original instruction with a jump instruction opcode; and search for a cached version of the injected instruction embedded with the probe.

In yet another embodiment of the present disclosure, a non-transitory computer readable storage medium comprising executable instructions that when executed by one or more processors cause the one or more processors to: receive a plurality of computer-executable instructions from memory; identify at least one original instruction from the received plurality of computer-executable instructions for facilitating insertion of a probe; create a temporary copy of the at least one original instruction; and allocate a jump target of the probe to a memory address in the memory by assigning a predetermined value to tail bytes of the probe.

In one aspect of the embodiment, the executable instructions when executed by one or more processors cause the one or more processors to: determine whether the allocation of the jump target of the probe is successful based on an availability of the memory address; generate an injected instruction embedded with the probe based on the allocated jump target of the probe; and activate the probe in the injected instruction based on a validity of the pun.

Additional features and advantages of the present disclosure will become apparent to those skilled in the art upon consideration of the following detailed description of the illustrative embodiment exemplifying the best mode of carrying out the invention as presently perceived.

### BRIEF DESCRIPTION OF THE DRAWINGS

The embodiments will be more readily understood in view of the following description when accompanied by the below figures and wherein like reference numerals represent like elements, wherein:

FIG. 1 is a schematic block diagram illustrating one example of a system for injecting a probe into a computer-readable computer program in accordance with embodiments of the present disclosure;

FIG. 2 is a schematic block diagram of an exemplary probe injection unit of the system shown in FIG. 1;

FIG. 3 illustrates a visualization of exemplary configurations of an injected instruction and an original instruction used in the system shown in FIG. 1;

FIG. 4 illustrates an exemplary patching protocol performed by a probe site patch unit for patching a five byte call instruction with a jump in accordance with embodiments of the present disclosure;

FIG. 5 illustrates an exemplary configuration of a “trampoline” (a code region for dynamically generating a new function call instruction sequence) used in the system shown in FIG. 1; and

FIG. 6 is a flow chart illustrating an exemplary method of executing the system shown in FIG. 1 in accordance with embodiments of the present disclosure.

Corresponding reference characters indicate corresponding parts throughout the several views. Although the drawings represent embodiments of the present disclosure, the drawings are not necessarily to scale and certain features may be exaggerated in order to better illustrate and explain the present disclosure. The exemplifications set out herein illustrate an exemplary embodiment of the disclosure, in one form, and such exemplifications are not to be construed as limiting the scope of the disclosure in any manner.

### DETAILED DESCRIPTION OF EMBODIMENTS

Dynamic binary instrumentation—rewriting binary instructions at runtime—is an important capability for a wide array of purposes ranging from instruction set architecture (ISA) emulation to performance profiling and debugging. Dynamic probe injection is a limited form of binary instrumentation in which a user-defined probe function is attached to execute every time its associated probed instruction is reached. A probe is a jump or trap instruction that overwrites the probed instruction, redirecting control flow to code that implements the probe function as well as any instructions overwritten by the probe.

For example, trap-based probes use an interrupt handler to invoke the probe function and then execute or emulate the probed instruction. Trap instructions are typically encoded with a single-byte (e.g., INT3 in the x86 instruction set) that fits at any probe site and can be written atomically, allowing trap-based probe injection anywhere in a program. The probe site refers to a region in memory 130 where the injected probe resides. This flexibility is offset by a substantial slowdown along the probed code path because each probe invocation incurs an interrupt and associated user/kernel-space transition. Trap-based probes are effective when they are active only for a short duration or restricted to avoid the hottest code locations.

As another example, a jump-based probe redirects execution directly to a probe function, or a trampoline that invokes the probe function, rather than relying on exceptions and signal handlers. The trampoline refers to a region of binary code, typically dynamically generated, which redirects control flow elsewhere. For example, control jumps into the trampoline and jumps out or bounces to a target location having the specific address. Jump-based probes result in probes with low invocation overhead, but rely on being able to safely replace the probe site with a multi-byte jump instruction. If the probed instruction is smaller than the jump, this technique overwrites adjacent instructions, which is unsound. These adjacent instructions can be a start of another basic block (e.g., the target of jump from elsewhere), or can be executing concurrently by another thread, and contain a valid instruction.

In one embodiment, a relative jump in a 64-bit version of an x86 instruction set (x86-64) includes five bytes which restrict a placement of probes to five-byte instructions. Conventional x86-64 jump-based probe implementations work around this limitation by ensuring, at compile time, that probed locations contain enough space to fit the probe. However, this approach sacrifices the ability to work with arbitrary binaries for which the source code is not available, and statically restricts probe-able locations. Moreover, compiler-created probe sites have a hidden cost. For example, by forcing the compiler to generate different code, or leave space, some latent overhead is inevitable.

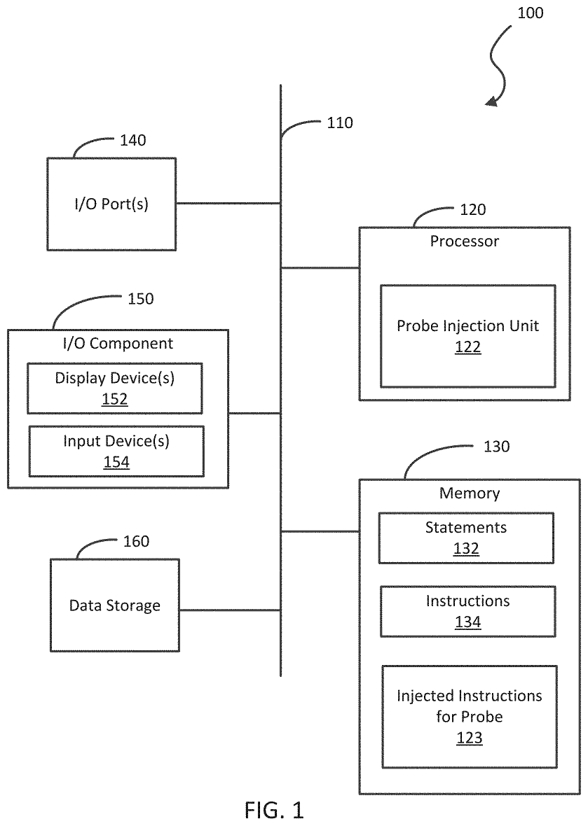

Referring now to FIG. 1, an exemplary system 100 for injecting a probe into a computer-readable computer program, in accordance with embodiments of the present disclosure is shown. In some implementations, system 100 includes any type of computing device suitable for implementing aspects of embodiments of the disclosed subject matter. Examples of computing devices include such “workstations,” “servers,” “laptops,” “desktops,” “tablet computers,” “hand-held devices,” “consoles,” “processing units,” “CPUs,” or “APUs,” and the like, all of which are contemplated within the scope of FIG. 1, with reference to various components of system 100.

In one embodiment, system 100 includes a bus 110 that, directly and/or indirectly, couples the following devices: a processor 120, a memory 130, an input/output (I/O) port(s) 140, an I/O component(s) 150, and a data storage 160, such as a non-transitory storage medium. Any number of additional components, different components, and/or combinations of components is also included in system 100. In some implementations, I/O component(s) 150 include a presentation component configured to present information to a user such as, for example, a display device, a speaker, a printing device, and/or the like, and/or an input component such as, for example, a microphone, a joystick, a satellite dish, a scanner, a printer, a wireless device, a keyboard, a pen, a voice input device, a touch input device, a touch-screen device, an interactive display device, a mouse, and/or the like.

Bus 110 represents one or more busses (such as, for example, an address bus, data bus, or combination thereof). Similarly, in some embodiments, system 100 includes a number of processors 120, a number of memory components 130, a number of I/O ports 140, a number of I/O components 150, and/or a number of storages 160. Additionally any number of these components, or combinations thereof, is distributed and/or duplicated across a number of computing devices.

In this example, processor 120 includes a probe injection unit 122 that is configured to inject a probe into the computer-readable computer program having a plurality of computer-executable instructions in accordance with one embodiment set forth in the disclosure. For example, probe injection unit 122 can be hardware component, but in another example, it can also be software component depending on the application. In one example, probe injection unit 122 can be software programs residing in memory 130. In one embodiment, memory 130 includes computer-readable media in the form of volatile and/or nonvolatile memory. In other embodiments, memory 130 is removable, nonremovable, or a combination thereof.

Media examples include Random Access Memory (RAM); Read Only Memory (ROM); Electronically Erasable Programmable Read Only Memory (EEPROM); flash memory; optical or holographic media; magnetic cassettes, magnetic storage devices; and/or any other medium that can be used to store information and can be accessed by a computing device such as, for example, quantum state memory, and/or the like. A distributed memory system shared in one or more servers (e.g., web servers or non-web servers) is also contemplated to suit different applications.

In this example, memory 130 stores computer-readable statements 132 of the computer program, and computer-executable instructions 134 for causing processor 120 to implement aspects of embodiments of system components discussed herein and/or to perform aspects of embodiments of methods and procedures discussed herein. During operation, injected instructions 123 for the probe generated by probe injection unit 122 temporarily resides in memory 130 for processing statements 132 and instructions 134. Further, statements 132 and instructions 134 are transmitted between and stored on data storage 160 and/or memory 130 via bus 110, as desired.

Computer-executable instructions 134 include, for example, computer code, machine-useable instructions, and the like, such as, for example, program components capable of being executed by one or more processors 120 associated with system 100. Program components are programmed using any number of different programming environments, including various languages, development kits, frameworks, and/or the like. Some or all of the functionality contemplated herein are also, or alternatively, implemented in hardware and/or firmware.

System 100 shown in FIG. 1 is not intended to suggest any limitation as to the scope of use or functionality of embodiments of the present disclosure. Neither should the illustrative system 100 be interpreted as having any dependency or requirement related to any single component or combination of components illustrated therein. Additionally, various components depicted in FIG. 1 are, in embodiments, integrated with various ones of the other components depicted therein (and/or components not illustrated), all of which are considered to be within the ambit of the present disclosure.

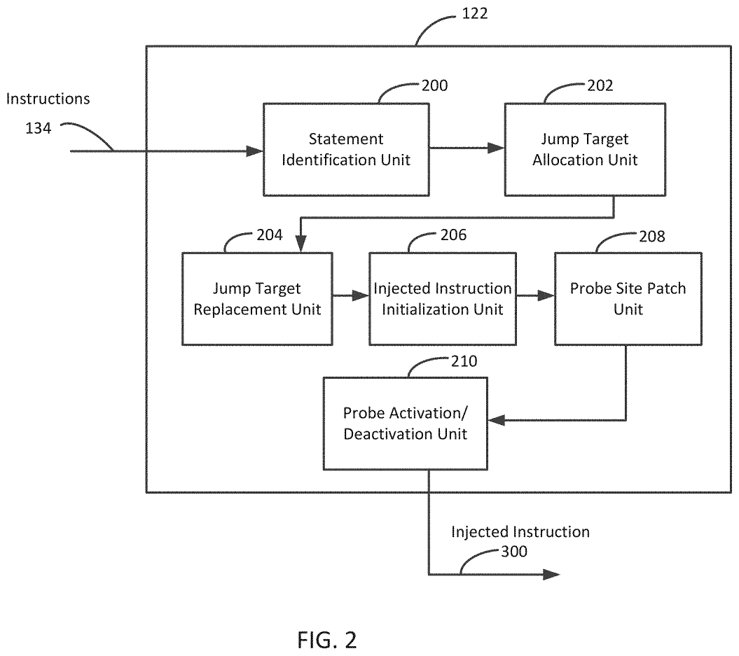

FIG. 2 illustrates an exemplary probe injection unit 122. Embodiments of the present disclosure are described below by way of example only, with reference to the accompanying drawings. Further, the following description is merely exemplary in nature and is in no way intended to limit the disclosure, its application, or uses. As used herein, the term “unit” refers to, is part of, or includes an Application Specific Integrated Circuit (ASIC), an electronic circuit, a processor or microprocessor (shared, dedicated, or group) and/or memory (shared, dedicated, or group) that executes one or more software or firmware programs, a combinational logic circuit, and/or other suitable components that provide the described functionality. Thus, while this disclosure includes particular examples and arrangements of the units, the scope of the present system should not be so limited since other modifications will become apparent to the skilled practitioner.

Referring now to the example shown in FIGS. 1 and 2, the probe injection unit 122 includes a statement identification unit 200, a jump target allocation unit 202, a jump target replacement unit 204, an injected instruction initialization unit 206, a probe site patch unit 208, and a probe activation and deactivation unit 210. Although these sub-units 200-210 are illustrated as children units subordinate of the parent unit, each sub-unit can be operated as a separate unit from probe injection unit 122, and other suitable combinations of sub-units are contemplated to suit different applications. In another embodiment, one or more units can be selectively bundled as a key software model running on processor 120 having software.

In one embodiment, probe injection unit 122 is configured to provide a jump-based probe injection instruction that has the flexibility of probing any instruction in an unmodified x86-64 binary without an invocation cost of a trap-based approach. One aspect of probe injection unit 122 is a dual nature of code as data, specifically, that address-offset bytes in a jump instruction can be simultaneously interpreted as instructions. This technique is called “instruction punning.”

For example, when a five-byte location to be patched contains multiple instructions, the first byte is the probed instruction, but the others remain valid jump targets, and retain their original semantics. Although the five-byte instruction is described herein, any length (e.g., 32- or 64-byte instructions) of instruction is also contemplated to suit the application. In one example, a 64-bit version of the x86 instruction set (x86-64) has 15-type maximum length instructions. This patch can be accomplished by leaving trailing instructions in place, reinterpreting them as a jump offset. Hence, probe injection unit 122 can write as little as one byte to activate a jump-based probe—just like a trap-based probe. If it is not possible to leave the trailing instructions untouched, probe injection unit 122 instead replaces them with trap or illegal instructions, which redirect control to a signal handler to emulate displaced instructions.

In another example, when writing more than one byte, it is important to ensure that probe injection unit 122 patches a running code. A patching operation appears atomic with respect to program execution. If the application is single threaded, this is straightforward. When there are multiple concurrent threads in the application, an additional protocol is needed to ensure cache-line-straddling instructions are patched safely. Detailed description of probe injection unit 122 is provided below.

Statement identification unit 200 is configured to receive a plurality of computer-executable instructions 134 from memory 130 and identify at least one original instruction from the plurality of computer-executable instructions 134 for facilitating insertion of a probe. Each original instruction includes an operation code (“opcode”) that performs a specific operation (e.g., “A” opcode for ADD or “M” opcode for MOV) and a jump target that represents a memory location of the specific operation. In one example, the memory location is a relative address offset in memory 130, and in another example, the memory location is an absolute pointer directing to a physical memory location of memory 130.

During a probe injection process, statement identification unit 200 is configured to create a temporary copy of the original instruction and replace a head byte of the original instruction with a jump instruction opcode. In one embodiment, the opcode has a single head byte and the jump target has four tail bytes. Any suitable numbers of head or tail bytes are also contemplated to suit different applications. For example, in a variable-length x86-64 architecture, the original instruction includes a relative jump encoded as an “e9” jump instruction opcode and a four byte relative, signed integer offset.

Specifically, if a probe site holds an instruction of five-bytes or more in length, the instruction head (first byte of the instruction) is overwritten with “e9” and the following four-bytes is overwritten with a predetermined relative offset. The probe site refers to a region where the injected probe resides. As an example, an instruction head is denoted with a capital letter.

$$\frac{A b c d e}{e 9 w x y z} \begin{matrix}\# Original five bytes \\ \# Activated probe\end{matrix}$$

This injected probe represents a relative jump to an instruction address in memory 130 generated by interpreting “wxyz” bytes as a 32-bit offset, “zyxw” (stored in little-endian), and adding it to the address of A. In one embodiment, each activated probe has a jump target containing a runtime-generated trampoline, where the trampoline assumes responsibility for executing displaced instructions. In this example, only one instruction starting with “A” is included in the original instruction “Abcde” is displaced, together in the trampoline with a full function call to the function attached to the probe.

Jump target allocation unit 202 is configured to allocate the jump target of the probe to an available (or free) memory address by assigning a predetermined value to the tail bytes (e.g., for a trampoline). In one embodiment, all tail bytes are replaced with an unconstrained offset selected from a full space of available numbers. This allows the trampoline to live anywhere, but limits the probe injection framework to five byte instructions. In another embodiment, if it is acceptable to selectively map regions of virtual memory, fully-unconstrained offset bytes may not be necessary. For example, it is possible that the original instruction bytes, “bcde,” are a valid offset for a trampoline. In such a case, only the single A byte is modified to “e9” and reinterpret the original “bcde” instruction bytes as an offset. Thus, none of the tail bytes is replaced with a new offset value but remains the same. In this case, the predetermined value is identical to the tail bytes in the original instruction. The ability to reinterpret code as a relative offset is the observation that allows system 100 to implement a fast, scalable, probe-anywhere framework.

In another example, the four byte suffix (i.e., tail bytes) can contain instruction heads when the instruction at A is less than five bytes in length. Capitalized letters denote these instruction heads, such as a two-instruction “AbCde” layout or five-instruction “ABCDE” layout. A 32-bit value for the (b|B)(c|C)(d|D)(e|E) fields is called a pun. The pun refers to a jump target representing both a memory location of the trampoline and an operation address of the original instruction corresponding to each opcode (e.g., “A” or “C”). Finding a pun for each instrumentation site that is both (1) a valid offset to a trampoline and (2) compatible with the original instruction layout while minimizing trampoline memory overhead is a unique technique at the heart of the punning approach of system 100.

In some embodiments, the punning approach of system 100 works for almost all x86-64 binaries, but includes unique aspects. Specifically, a single parse of an instruction stream starting from known entry points yields all instructions. Reusing the suffix of one instruction as another instruction is rare in application code. Program binaries that do not already have punning are used. Also, by requiring dynamic linking, only one copy of the probing library is active to prevent interference between multiple copies of the library.

In another embodiment, a unique trampoline is used per probe site, which allows the trampoline to encode a fixed, direct call. However, an alternative approach can be used to allow shared trampolines between probe sites. For example, the shared trampolines are dispatched at runtime, looking up the probe site, finding its associated instrumentation function, and indirectly jumping to the function. Advantageously, shared trampolines reduce memory usage in exchange for increased probe invocation overhead.

Jump target replacement unit 204 is configured to search for a memory space for the pun by replacing zero or more bytes of the tail bytes such that the jump target is mappable in memory 130. For example, if any allocatable memory area is found for the code trampoline, the original tail bytes can be left unchanged. Each valid pun has a valid jump target in a memory region that can be successfully mapped (e.g., using an “mmap” system call). In one example, for a patch site, there are 16 possible instruction layouts, from Abcde to ABCDE. For example, the first byte, “A,” is guaranteed to be an instruction head, because probes are typically injected at the site of valid instructions. However, the latter four bytes can each be either an instruction head (or not), yielding 16 possibilities. The search for puns is constrained by the presence of instruction heads in the last four bytes. At one extreme, “Abcde,” can take on any value for “bcde,” giving a full 2³² possible relative offsets. At the other extreme, “ABCDE” can only take values of B, C, D, and E that can each, individually, serve as instructions.

In this most-constrained “ABCDE” layout, with five one-byte instructions, the original values of “BCDE” cannot be relied on as being mappable memory. Further, when a negative offset is formed in the tail bytes or the jump target is already mapped, jump target replacement unit 204 deactivates one or more operations in the tail bytes with an illegal or trap instruction, and searches for the available memory address by replacing zero or more bytes of the tail bytes with a predetermined value. For example, a signal handler infrastructure of an operating system is used to execute an INT3 trap instruction (e.g., x86 opcode 0xCC) and replace any subset of the four-instructions in the “BCDE” suffix.

In some embodiments, this INT3 technique alone is insufficient, and does not yield a large enough set of potential puns. Also, the 0xCC results in a negative offsets if placed in the E byte, which typically lead to invalid jumps to addresses below zero. INT3 is not the only single-byte instruction that can trigger the signal handler. Alternatively, a SIGILL handler can also be used. Naturally, the x86 architecture allows software to recover from SIGILL, but in some languages or operating systems this can go beyond allowed or standardized behavior. For example, there are fourteen x86-64 illegal instructions with single-byte opcodes, which correspond to the following decimal values: 6 7 14 22 23 30 31 39 47 55 63 96 97 98. Dependence on illegal instructions means that a library based on this principle can be installed based on microarchitecture. A new processor that introduces new instructions may naturally decrease the set of illegal opcodes. With the additional option of illegal instructions, each byte in the four-byte tail can be treated according to the following decision tree using jump target replacement unit 204:
1. Head-of-instruction byte, B, C, D, or E
(a) except for E replace with a trap instruction, which passes control to the SIGINT signal handler.
(b) replace with a known illegal opcode, which passes control to the SIGILL signal handler.
(c) leave the original instruction, but if it's multi-byte the entire instruction is left alone.
2. Non-head byte of A instruction: always free, 256 possibilities.
3. Non-head byte c, d, or e of instruction starting at B, C, or D: free IFF the head byte was made into an illegal or trap, otherwise constrained to remain at its original value.

In this example, the algorithm presented above uses a deterministic search order through combinations of illegal instructions. The reason for this is to enable two nearby probe-sites to use the same trampoline offset so that their trampolines also lie close together. This increases the probability that the second trampoline can fall within the already allocated memory page for the first trampoline, even without using a placement algorithm. The particular search order used here is simply that generated by a nested loop over instruction heads, though randomization and other search strategies are also contemplated.

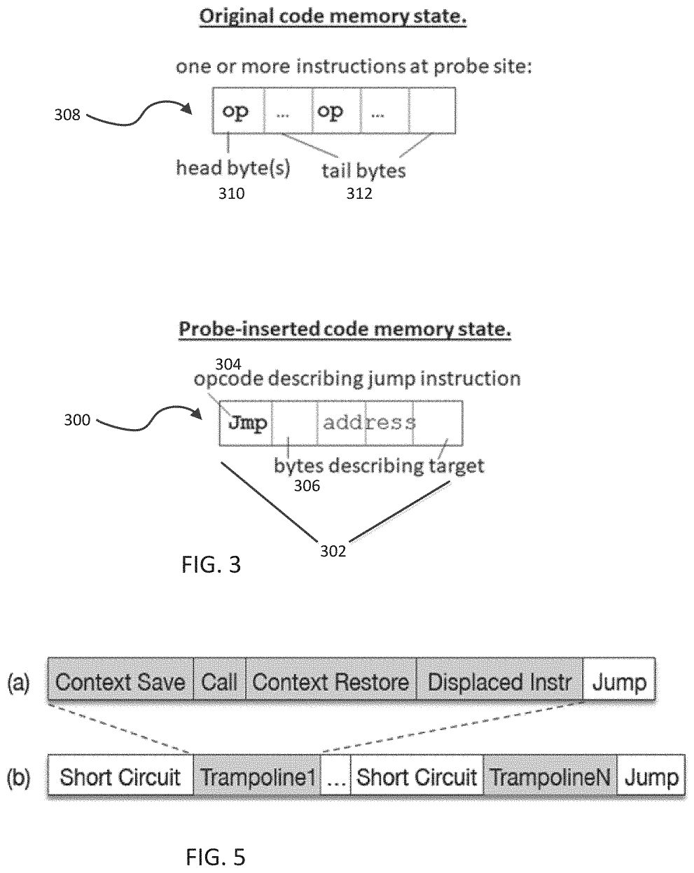

Referring now to FIG. 3, injected instruction initialization unit 206 is configured to generate an injected instruction 300 embedded with a probe 302 based on an allocated jump target determined by jump target allocation unit 202. Further, injected instruction initialization unit 206 is configured to initialize injected instruction 300 with probe 302 having an opcode 304 representing a jump instruction (e.g., “e9”), and a pun 306 representing the allocated jump target (e.g., “wxyz”). As a result, an original instruction 308 having a head byte 310 and an associated tail byte(s) 312 is replaced with injected instruction 300 by injected instruction initialization unit 206. As discussed above, each original instruction 308 can have one or more head bytes 310 and each head byte 310 is associated with one or more tail bytes 312 to suit different applications.

Each pun 306 is linked to the trampoline, and an amount of memory used by trampoline is constant. However, a number of trampoline pages mapped in virtual memory is a function of pun selection strategy. It is desirable to spread out trampolines so as not to collide with each other, but cluster them within a page when possible. In addition to the degrees of freedom in pun 306 (offset) selection described above, it is also beneficial to remember that the jump offset is relative to the address of the probe site. Thus, the distribution of probe sites within the code pages of the application provides a natural source of entropy in the low 12 bits that determine intra-page alignment.

Probe site patch unit 208 is configured to patch injected instruction 300 that is divided at a probe site based on opcode 304 and pun 306 such that injected instruction 300 is contiguous at a cache line boundary in memory 130. In one embodiment, probe site patch unit 208 includes an algorithm designed to patch up to eight adjacent instruction bytes in an x86-64 architecture. At its core is the hypothesis that there exists some upper bound, Tmax, on the time between which one core modifies a code-containing cacheline, and all other cores “see” this modification. For example, the existence of Tmax is empirically determined, and found that this value ranges from 400-2000 cycles on current microarchitectures.

In one example, a single instruction is included in patch-injected instruction 300 at a probe site. In another example, a five-byte instruction as Abcde is used where the capitalized byte, A, is the instruction head and is at a lowest address. If the instruction is broken over a cache line boundary, probe site patch unit 208 writes, for example, “Abκde,” where “|” is dividing the instruction into a front region and a back region, split by the cache line boundary. During patching, probe site patch unit 208 can lock the instruction by replacing the “A” byte—and only that byte—with a trap instruction: INT3 (e.g., 0xCC), before waiting Tmax, and writing the back region “cde,” waiting, and writing the front region “Ab.” This “locking” prevents any threads executing the instruction while being mutated, by redirecting the control to a trap handler. This protocol is necessary because of the incoherent view of memory on instruction fetch, which can completely ignore atomic instructions.

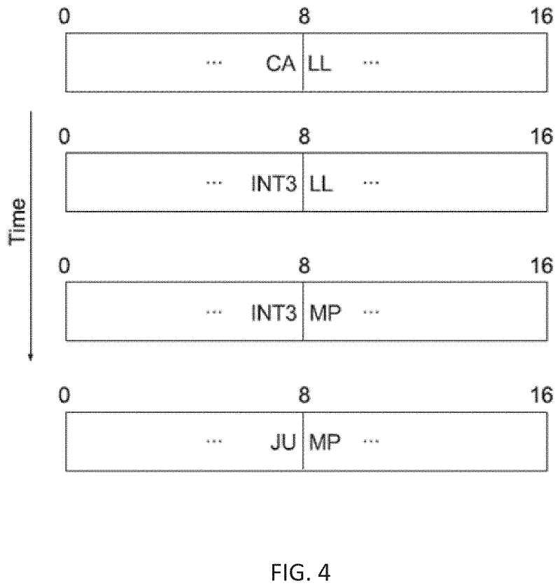

FIG. 4 illustrates an exemplary patching protocol performed by probe site patch unit 208 for patching a five byte call instruction with a jump. The protocol proceeds starting from the top. The cache-line boundary is the divide in the middle, with word boundaries numbered at top. Here, an instruction mnemonics is used in lieu of actual opcodes to show a patching order of the front and back regions of a straddling instruction.

First of all, probe sites are considered that contain multiple instructions within a five-byte range, for example, “AbC|de.” This is a two-instruction sequence with instruction heads (valid program-counters) at A and C. In this case, the second instruction, “Cde,” is a “straddler” which is bisected by a cache line boundary.

In one example, only the first of five bytes (A) is locked with a trap instruction, but in another example, a straightforward generalization is used where INT3 traps are written to all bytes before the split: here A, b, and C. This means that it is not necessary to parse the layout of the patch site within the patching layer, but it is necessary to be careful to resume the computation at the right place upon return from the SIGINT signal handler.

In some embodiments, it is important to minimize an instruction pun crossing a basic block boundary. In fact, sometimes it is necessary to prevent it. For example, if it is desired to instrument a function exit, the instrumentation point would typically be a single byte “ret” instruction at the end of the function. Since a pun needs to be five bytes in length in this example, it would extend four bytes beyond the boundaries of the current function and it may be overwriting a different function, placed after the current one, but potentially separated by an unknown gap that confounds instruction decoding. For internal basic blocks, it is possible to do puns across boundaries, but avoiding them prevents the possibility that the pun induces signals during execution of instructions in the adjacent, unrelated block. Hence, this reduces a number of signals taken, improving the performance.

In one example, when a pun falls across a basic block boundary, including off the end of the function at a one-byte “ret” instruction, it is attempted to back-track in the instruction stream to find a probe insertion location that can avoid modifying the successor block (or function). This eliminates signals resulting from jumps directly into the pun. Given that the execution of one instruction in the basic block implies execution of all the instructions in the basic block, this mechanism is indistinguishable from probing at the initial site.

Thus, it may be beneficial to search for an upstream insertion location that either is a 5-byte instruction or has a valid pun. In such a case, the probe insertion site cannot overlap the original instruction. In these situations, a trap is used at the instruction site, in addition to inserting the upstream probe, and a trampoline is used that emulates the entire span of bypassed instructions. This results in low invocation overheads while protecting against missed probes from concurrent thread execution during the insertion operation. Also, the trap protects against scenarios where basic blocks are incorrectly identified, and suspected-unreachable downstream instructions are actually the target of jumps.

If there is not enough space to backtrack inside the basic block, a fall back strategy is a trap-based implementation for this specific probe site, rather than continuing to search into all predecessor blocks. Probe site patch unit 208 balances the overhead of suboptimal trap-based probes, versus the overhead of excessive dynamic inspection of the application during probe registration.

Probe activation/deactivation unit 210 is configured to activate or deactivate probe 302 in injected instruction 300 based on a validity of pun 306. In one example, probe 302 is activated when pun 306 has a valid jump target in memory 130 that can be successfully mapped for the trampoline. In another example, probe 302 is deactivated when probing operation is completed after a predetermined time period. After the deactivation of probe 302, injected instruction 300 is overwritten based on content information of the temporary copy of the original instruction.

FIG. 5 illustrates an exemplary configuration of a trampoline. In this example, “context save” and “context restore” sandwich the “call” to an instrumentation function. Here, a baseline trampoline consumes 113 bytes, but this number can change due to the present method for rewriting position-dependent instructions to reflect their displaced address.

For bytes displaced from an original probe site, the contained instructions are classified as being position independent or not. The position-independent instructions are copied into the trampoline verbatim. In the case of position-dependent instructions, the instructions are updated, including changing relative addresses and substituting one sequence for another in some cases which can add a number of extra bytes. An example of such a substitution is replacing a short conditional jump which becomes out of reach when displaced, with another conditional jump plus a near jump.

Probing two instructions that are less than five bytes apart can happen due to the backtracking process described above. In such a situation, the existing trampoline is copied into a newly generated trampoline to create a super-trampoline. A new pun is created that jumps to this composite trampoline. Formats of a trampoline and super-trampolines are shown in FIG. 5. A key feature is that while a super-trampoline contains N distinct probes, and all the displaced code in between, each probe can be independently deactivated. This is accomplished using a short circuit before each nested trampoline for disabling each individual probe. The short circuit is set to a noop (or no operation) to activate, and to a short jump over the trampoline to deactivate.

In one embodiment, punning includes a memory allocation at a fixed address. For example, a fixed address memory allocator is used which fails if it cannot allocate requested memory at a given address. In one example, the “mmap” instruction is used to attempt a MAP_FIXED mapping, and failing means either that the memory is already mapped (e.g., by an application), or that it is mapped by another application but a given position is already occupied by a trampoline. In another example, punning continues until an allocatable address is found in the memory. In another embodiment, a coarse approximation is used for determining where the stack and heap are, to quickly and conservatively rule out potential trampoline targets that would interfere with either. For example, a single memory allocator region (also called an arena) is created for each given 2³² byte region that contains the trampolines of activated probes for unconstrained probe sites. Trampolines are bump-allocated within their corresponding arena.

The invalid instructions used in punning are not meant to be hit often. After all, most executions go through the instruction at the “A” byte. Only jumps directly to the “B, C, D, or E” bytes—or threads that were preempted at those locations—cause control flow to reach an illegal instruction. In either case, the execution is redirected to the SIGILL signal handler. Within the handler, the address of the illegal instruction is inspected to determine the analogous offset inside the trampoline and resume there. Thus, if there are multiple instruction heads replaced with illegal instructions within the pun, each redirects to the corresponding displaced instruction in the trampoline.

In further embodiments, additional search strategies are contemplated when punning, thereby making trampoline layouts more optimal. In one example, an algorithm is forced to wait Tmax time twice whenever patching a straddling instruction (e.g., after locking the front region, and again after writing the back region). If both sides of a cache line boundary are patched, this protocol remains necessary. But, in the instruction punning approach, there is room to optimize by avoiding the necessity of updating the back portion.

With punning, only the first byte is patched (e.g., to “e9”) for a relative jump. The address bytes may or may not need to be modified. This depends on the set of possible offsets, which are searched. In performing this search, the knowledge that the patch site straddles a cache line increases the incentive to leave constant the portion of the address that spills onto the next cache line.

It is possible to do several optimizations when laying out trampolines. Some of the usual ones found in literature are register liveness analysis and instrumentation inlining With register liveness analysis, it is possible to skip saving registers which are not live at the instrumentation point. Instrumentation inlining within the trampoline saves an additional indirect call which is suited for small instrumentation functions. Additionally, optimizations like aggressive combining of multiple trampolines can avoid multiple jumps back and forth from the mainline code and the trampolines. If a significant number of probe-sites are located in close proximity, some fall within the same basic block. And if that leads to relocating entire basic blocks, techniques similar to trace linking can further reduce jump costs to and from trampolines.

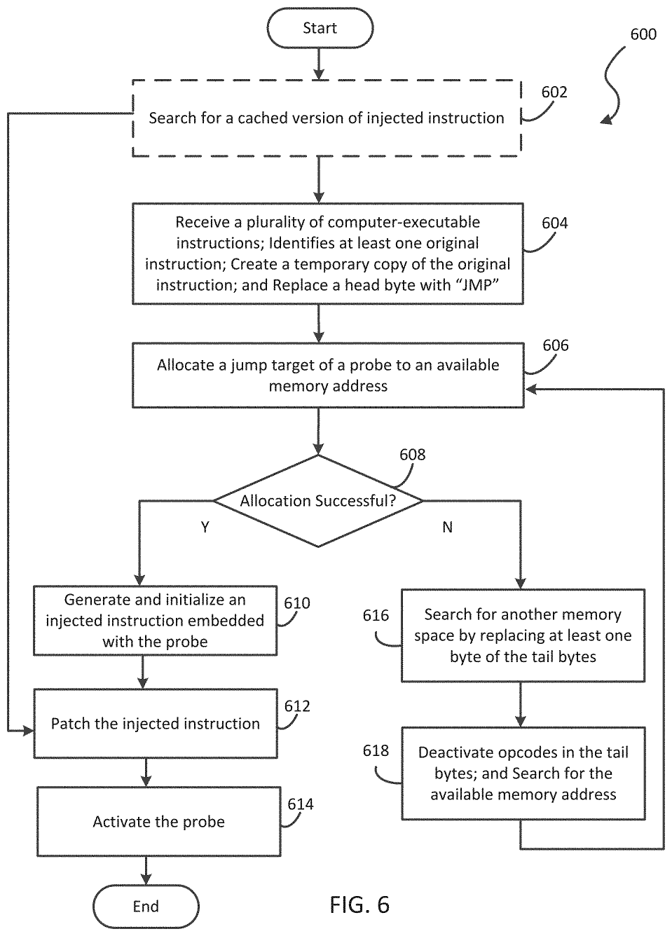

Referring now to FIG. 6, an exemplary method 600 is illustrated for dynamically injecting a probe into a computer-readable computer program having a plurality of computer-executable instructions 134 using instruction punning techniques. It will be described with reference to FIGS. 1-5. Like reference numerals represent like elements shown in FIGS. 1-5. However, any suitable structure can be employed.

In step 602, statement identification unit 200 optionally searches for a cached version of injected instruction 300 embedded with probe 302. For example, when the cached version of injected instruction 300 is found in memory 130, control proceeds to step 612. Otherwise, control proceeds to step 604. In step 604, statement identification unit 200 receives a plurality of computer-executable instructions 134 from memory 130 and identifies at least one original instruction 308 from the received plurality of computer-executable instructions 134 for facilitating insertion of probe 302. Statement identification unit 200 creates a temporary copy of original instruction 308 and replaces a head byte of original instruction 308 with a jump instruction opcode. For example, when original instruction 308 has a single opcode “A” and tail bytes of “bcde,” the head byte of “A” is replaced with “JMP” (e.g., “e9”).

In step 606, jump target allocation unit 202 checks to see whether a jump target of probe 302 is allocatable to a potentially available memory address by assigning a predetermined value to the tail bytes of original instruction 308. For example, in a five-byte instruction, the tail bytes of “bcde” is completely unconstrained, and thus jump target allocation unit 202 attempts any 32-bit jump target (e.g., an integer value between 0 and 255). If the memory address having the value of tail bytes of “bcde” is free and available for use, then no need to replace any of the tail bytes. However, if a memory location having the address “bcde” is occupied or damaged, then jump target allocation unit 202 assigns a new predetermined value (e.g., a random or prearranged number) to the tail bytes to determine whether the memory address of the new predetermined value is available.

In step 608, when the allocation of the jump target is successful or allocatable to the available memory address, control proceeds to step 610. Otherwise, control proceeds to step 616. If jump target allocation unit 202 finds the available memory address “wxyz” for the jump target linked to the trampoline, jump target allocation unit 202 replaces original instruction “Abcde” with “e9wxyz” to create injected instruction 300. In step 610, injected instruction initialization unit 206 generates injected instruction 300 embedded with probe 302 based on the allocated jump target determined by jump target allocation unit 202. Then, instruction initialization unit 206 initializes injected instruction 300 with probe 302 having opcode 304 and pun 306 based on the allocated jump target. In step 612, probe site patch unit 208 patches injected instruction 30 that is divided at a probe site based on opcode 304 and pun 306 such that injected instruction 300 is contiguous at a cache line boundary in memory 130. In step 614, probe activation/deactivation unit 210 activates probe 302 in injected instruction 300 based on a validity of pun 306.

In step 616, if jump target allocation unit 202 fails to find the available memory address for the jump target linked to the trampoline, jump target replacement unit 204 searches for the memory space for pun 306 by replacing zero or more bytes of the tail bytes such that the jump target is mappable in memory 130. For example, if original instruction 308 has two instructions in 5 bytes, “AbCde,” jump target replacement unit 204 replaces “b” with a predetermined value. In this example, “A” and “C” are instruction heads and “bCde” are the tail byes, which becomes the jump target. “b” and “de” are non-operation tail bytes, which are not instruction heads.

In step 618, jump target replacement unit 204 deactivates one or more operations (e.g., opcodes) in the tail bytes with an illegal or trap instruction. For example, if the replacement of “b” is unsuccessful in securing the available memory address, jump target replacement unit 204 replaces “C” with any illegal or trap instruction (e.g., trap=0xcc on x86, or any of 14 total possibilities on x86). When the “C” instruction is thus deactivated, “d” and “e” can be replaced with any of 0-255 values to search for the available memory address for the jump target. Control returns to step 606.

Again, in step 606, jump target allocation unit 202 allocates the jump target of the probe to the available memory address. In step 608, if the available memory address is found for the jump target of injected instruction 300 by jump target allocation unit 202, control proceeds to step 610. In step 610, for example, if the available memory address is now “xYzw” where the tail bytes represent an arbitrary 32-bit jump target and “Y” is a valid instruction head, instruction initialization unit 206 initializes injected instruction 300 by replacing original instruction 308 having “AbCde” with injected instruction 300 having “e9xYzw.”

As such, the present systems and methods shown above may incur zero latent probe overhead. Additionally, the patch protocol described above is improved to support patching of contiguous instructions, while retaining its probe toggling scalability characteristics. In this example, an x86_64-specific instruction punning framework is described that confirms the feasibility of this technique. It was discovered that the present probe injection methods and systems are orders of magnitudes cheaper than conventional systems and methods. Further, the present instruction punning systems methods can be used on a range of SPEC applications and show that instrumentation overheads are acceptably low with a geomean probe insertion overhead of 0.93% application runtime and a memory overhead of 0.09% for instrumenting all function boundaries.

The above detailed description and the examples described therein have been presented for the purposes of illustration and description only and not for limitation. For example, the operations described can be done in any suitable manner. The methods can be performed in any suitable order while still providing the described operation and results. It is therefore contemplated that the present embodiments cover any and all modifications, variations, or equivalents that fall within the scope of the basic underlying principles disclosed above and claimed herein. Furthermore, while the above description describes hardware in the form of a processor executing code, hardware in the form of a state machine, or dedicated logic capable of producing the same effect, other structures are also contemplated.

What is claimed is:

1. A method, by a computing device, of injecting a probe (302) into a computer-readable computer program having a plurality of computer-executable instructions (134), comprising:
receiving, using the computing device, the plurality of computer-executable instructions (134) from memory (130);
identifying, using the computing device, at least one original instruction (308) from the received plurality of computer-executable instructions (134) for facilitating insertion of the probe (302);
creating, using the computing device, a temporary copy of the at least one original instruction (308); and
allocating, using the computing device, a jump target of the probe (302) to a memory address in the memory (130) by assigning a predetermined value to tail bytes (312) of the probe (302).

2. The method of claim 1, further comprising determining, using the computing device, whether the allocation of the jump target of the probe (302) is successful based on an availability of the memory address.

3. The method of claim 1, further comprising generating, using the computing device, an injected instruction (300) embedded with the probe (302) based on the allocated jump target of the probe (302).

4. The method of claim 3, further comprising initializing, using the computing device, the injected instruction (300) with the probe (302) having an opcode (304) and a pun (306) based on the allocated jump target.

5. The method of claim 4, further comprising responding to the injected instruction (300) being split at a probe (302) site by patching, using the computing device, the injected instruction (300) based on the opcode (304) and the pun (306).

6. The method of claim 4, further comprising activating, using the computing device, the probe (302) in the injected instruction (300) based on a validity of the pun (306).

7. The method of claim 4, further comprising searching, using the computing device, for a memory space for the pun (306) by replacing zero or more bytes of the tail bytes (312) such that the jump target is mappable in the memory (130).

8. The method of claim 4, further comprising deactivating, using the computing device, one or more operations in the tail bytes (312) with an illegal or trap instruction.

9. The method of claim 8, wherein deactivating the one or more operations is performed when the memory address is unavailable.

10. The method of claim 1, further comprising replacing, using the computing device, a head byte (310) of the original instruction (308) with a jump instruction opcode (304).

11. The method of claim 1, further comprising searching, using the computing device, for a cached version of the injected instruction (300) embedded with the probe (302).

12. A computing device having a processor (120) operative to inject a probe (302) into a computer-readable computer program having a plurality of computer-executable instructions (134), the processor (120) being configured to:
receive the plurality of computer-executable instructions (134) from memory (130);
identify at least one original instruction (308) from the received plurality of computer-executable instructions (134) for facilitating insertion of the probe (302);
create a temporary copy of the at least one original instruction (308); and
allocate a jump target of the probe (302) to a memory address in the memory (130) by assigning a predetermined value to tail bytes (312) of the probe (302).

13. The computing device of claim 12, wherein the processor (120) is further configured to determine whether the allocation of the jump target of the probe (302) is successful based on an availability of the memory address.

14. The computing device of claim 12, wherein the processor (120) is further configured to generate an injected instruction (300) embedded with the probe (302) based on the allocated jump target of the probe (302).

15. The computing device of claim 14, wherein the processor (120) is further configured to initialize the injected instruction (300) with the probe (302) having an opcode (304) and a pun (306) based on the allocated jump target.

16. The computing device of claim 15, wherein the processor (120) is further configured to:
respond to the injected instruction (300) being split at a probe (302) site by patching the injected instruction (300) based on the opcode (304) and the pun (306); and
activate the probe (302) in the injected instruction (300) based on a validity of the pun (306).

17. The computing device of claim 15, wherein the processor (120) is further configured to:
search for a memory space for the pun (306) by replacing zero or more bytes of the tail bytes (312) such that the jump target is mappable in the memory (130); and
deactivate one or more operations in the tail bytes (312) with an illegal or trap instruction when the memory address is unavailable.

18. The computing device of claim 12, wherein the processor (120) is further configured to:
replace a head byte (310) of the original instruction (308) with a jump instruction opcode (304); and
search for a cached version of the injected instruction (300) embedded with the probe (302).

19. A non-transitory computer readable storage medium comprising executable instructions (134) that when executed by one or more processors (120) cause the one or more processors (120) to:
receive a plurality of computer-executable instructions (134) from memory (130);
identify at least one original instruction (308) from the received plurality of computer-executable instructions (134) for facilitating insertion of a probe (302);
create a temporary copy of the at least one original instruction (308); and
allocate a jump target of the probe (302) to a memory address in the memory (130) by assigning a predetermined value to tail bytes (312) of the probe (302).

20. The non-transitory computer readable storage medium of claim 19, further comprising executable instructions (134) that when executed by one or more processors (120) cause the one or more processors (120) to:
determine whether the allocation of the jump target of the probe (302) is successful based on an availability of the memory address;
generate an injected instruction (300) embedded with the probe (302) based on the allocated jump target of the probe (302); and
activate the probe (302) in the injected instruction (300) based on a validity of the pun (306).
